(19) United States
(12) Patent Application Publication
(10) Pub. No.: US 2011/0212777 A1
(43) Pub. Date: Sep. 1, 2011

(54) Game device enabling three-dimensional movement

(75) Inventors: Chien-Yuan Chen, Banciao City (TW); Yi-Sheng Chen, Banciao City (TW)

(73) Assignee: Power Digital Communications Co., Ltd.

(21) Appl. No.: 12/081,581

(22) Filed: Apr. 17, 2008

(51) Int. Cl. A63F 13/00

(52) U.S. Cl. 463/32

(57) ABSTRACT

The present invention primarily includes a main game machine, a remote control signal transmitter and a video display unit, in which the main game machine is structured from a microprocessor, a memory and a wireless transceiver. The main game machine is thin and small in size, and is directly inserted into an Input/Output interface slot of the display unit, Distance and position of signals received by the wireless transceiver are measured, and then analyzed by a calculating machine and transmitted to the video control device, thereby enabling an operator to direct view animated images on a screen. Furthermore, a screen device can be directly disposed on the remote control signal transmitter.

### BACKGROUND OF THE INVENTION

(a) Field of the Invention

The present invention provides an improved game device enabling three-dimensional movement that is designed with an extremely thin and small game device that is easy to operate, has a light, portable and simple structure, and has a small main game machine similar in size to a card, which is not only provided with telecommunication transmission functionality, moreover, is provided with game remote control functionality.

(b) Description of the Prior Art

The game machine, named Wii, currently marketed by Nintendo and enjoying extreme popularity, is provided with three-dimensional operation, as well as viewing functionality similar to a television set, including watching general videos and movies, reading webpages, news, and so on, And its greatest characteristic is its ability to make left, right, up, down, far and near three-dimensional movement relative to the front of the aforementioned functions, thereby enabling remote control of every kind of game scene displayed on the screen, and thus achieve game playing objective.

However, careful study of the Wii game machine reveals a somewhat complex structure, as depicted in FIG. 1, wherein the structure comprises a main game machine 1, a connecting line set 2, an optical sensor 3, a remote control 4 and a television set 5. The main game machine 1 is installed with a disk drive and a card reader 12, and is externally fixedly positioned using an auxiliary frame 11. Moreover, the main game machine 1 must be connected by wires to the television set 5, forming a transfer interface for the television screen. The connecting line set 2 provides AV (audio video) connecting lines, S terminal junctors, chromatic aberration terminal connecting lines and D terminal connecting lines which are respectively connected with the television set 5 and the optical sensor 3. In addition, the main game machine 1 further includes a network line 21 and an AC (alternating current) transformer 22. The remote control 4 establishes a signal connection with the main game machine 1 via wireless transmission, and is internally configured with triaxial acceleration sensor chip, a COMS (Complementary Metal-Oxide Semiconductor) infrared receiver, a speaker, a vibrating motor and a key switch. The main game machine 1 is used to transmit digital information read from the disk drive or card reader 12 to the screen of the television set 5 for displaying images thereon through the connecting line set 2. After using the remote control 4 to activate the game and remotely operate the game items, then power supply from the main game machine 1 enables a plurality of infrared LEDs (light-emitting diodes) located on the optical sensor 3 to emit infrared rays. When operating the remote control 4 to implement three-dimensional movement, then the infrared receiver senses the infrared rays transmitted by the optical sensor 3, thereby enabling the designated direction value to be calculated and transmitted to the main game machine 1. The main game machine 1 then collates and compares the information received, after which it instructs the main character of the game software to make a directional movement corresponding to that executed by the operator, thereby achieving the objective of three-dimensional game play.

However, if the household already has a computer, then there is no need for the additional functionality of online Internet browsing of webpages, news, and the like, provided by the Wii game machine. What current game players attach importance to is game functionality, and although the general television and network functionality supplemented by the Wii game machine have their effectiveness, however, it results in many additional units, such as the connecting line set 2, which requires an additional increase of 4 connecting lines, as well as the supplementary infrared optical sensor 3. Moreover, the main game machine 1 primarily receives signals from the remote control 4 and reads data to control the display of images on the screen; hence, if the Wii game machine is only used by the game player to play games, then the aforementioned unit contrivances are clearly unnecessary, and are the reasons for the Wii game machine being bulky, occupy space and have a high cost. Moreover, the Wii game machine must be connected to a television set in order to use, and is another primary cause for its inconvenience in use.

### SUMMARY OF THE INVENTION

A design objective of an improved game device enabling three-dimensional movement of the present invention is to meet the demands for a main game machine that provides simplicity of operation, has a light and portable structure, does not occupy space, and is slim and small in size

The improved game device enabling three-dimensional movement of the present invention can be used with devices able to display images, including television sets, portable computers or overhead projectors, and so on.

A remote control signal transmitter of the improved game device enabling three-dimensional movement of the present invention is applicable for use in a television remote control, a cellular phone, a PDA (Personal Digital Assistant), a wireless intercom, and the like.

Operating units of the improved game device enabling three-dimensional movement of the present invention are simple, and only include a video control device having television functionality and a remote control signal transmitter used to control game outcome.

The video control device of the improved game device enabling three-dimensional movement of the present invention is structured to comprise a microprocessor, a video control unit, a video display unit, a memory, a data reader device, a wireless receiver, a signal input terminal, and electronic gyroscopes, wherein the remote control signal transmitter is used to remotely control wireless reception and the electronic gyroscopes, and realize use for general operation or for use in game playing mode.

The remote control signal transmitter of the improved game device enabling three-dimensional movement of the present invention is structured to comprise basic units, including an optical sensor, a switch, a key set, a calculating machine, a microprocessor and a wireless transmitter unit, wherein the optical sensor is used to receive infrared signals emitted by the electronic gyroscopes of the video control device, and the calculating machine analyzes far and near distance data of infrared rays sensed by the wireless transmitter unit, and the data is transmitted to the video control device, thereby achieving the objective of three-dimensional game control.

The remote control signal transmitter of the improved game device enabling three-dimensional movement of the present invention can also be configured with an externally connected small video display, unit, a speaker and a card reader, thereby enabling stand-alone use of the remote control signal transmitter.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an implementation schematic view of a Wii game machine of the prior art.

FIG. 2 shows an implementation schematic view of the present invention.

FIG. 3 shows a structural block diagram of a video control device according to the present invention.

FIG. 4 shows a structural block diagram of a signal transmitter according to the present invention.

FIG. 5 shows an external view of a first embodiment of the signal transmitter according to the present invention.

FIG. 6 shows an external view of another embodiment of the signal transmitter according to the present invention.

FIG. 7 shows an external view of a third embodiment of the signal transmitter according to the present invention.

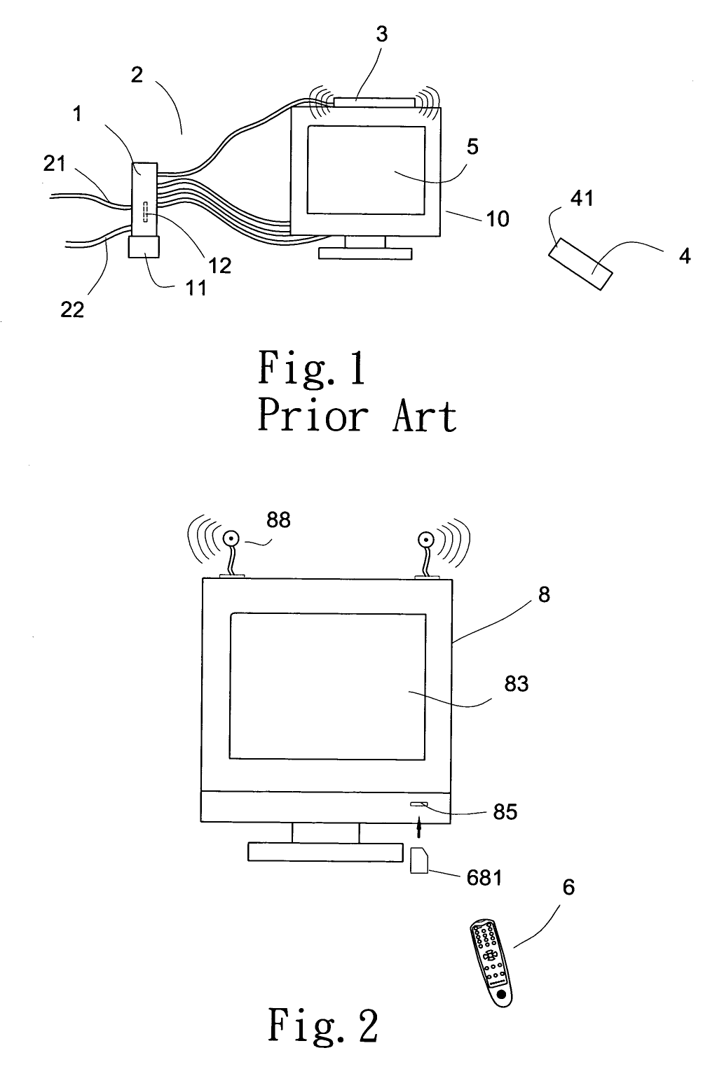

### DETAILED DESCRIPTION OF THE PREFERRED EMBODIMENTS

The design of an improved game device enabling three-dimensional movement of the present invention includes a slim, lightweight and portable main game machine which is simple to operate and does not occupy space, and is structured to comprise a microprocessor, a memory and a wireless transceiver, and which together with a remote control signal transmitter and a video display unit constitutes a system. Moreover, the main game machine can be directly inserted into an Input/Output interface slot of the video display unit. Referring to an embodiment of the present invention as depicted in FIG. 2, wherein a game machine 681, a storage media containing game microprocessor digital content for wireless transmission (such as Zigbee, Bluetooth, UWB (Universal Wide Band)), is first inserted into a data reader device 85, and the simple operating units, such as a video control device 8 having television functionality and a remote control signal transmitter 6, provide general television functionality or game functionality, thereby reducing a complicated wiring procedure, saving space and providing advancement. The remote control signal transmitter 6 is used to switch functional operation, thereby achieving the ability to activate a video display unit 83 using electronic gyroscopes 88, and enabling operation as a television set or a game machine.

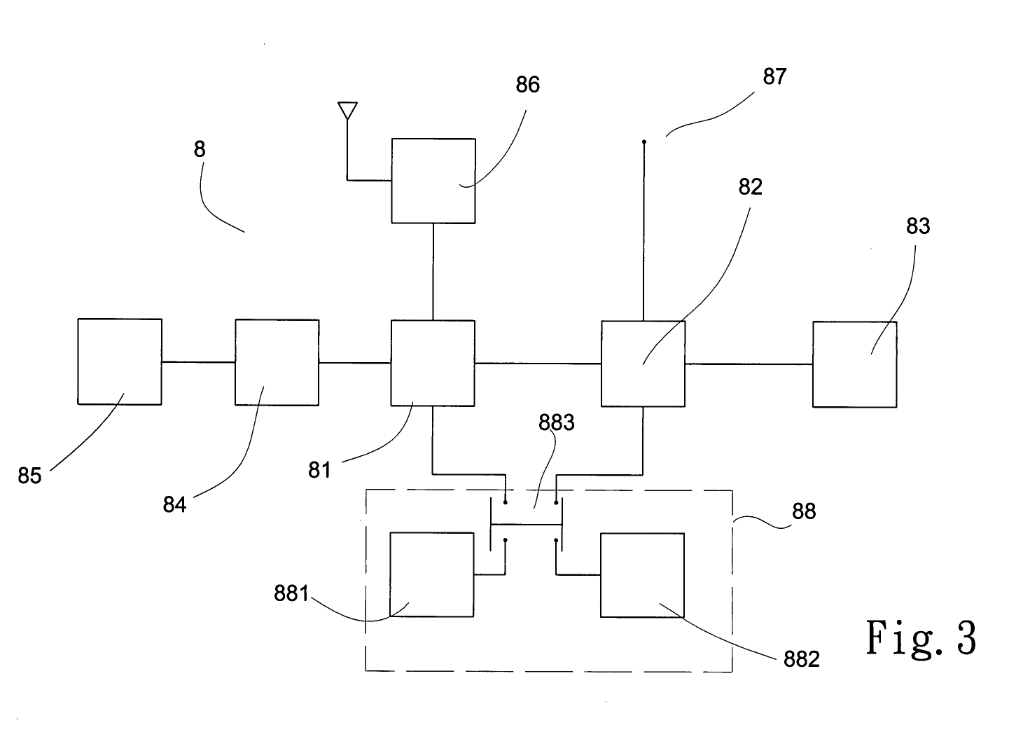

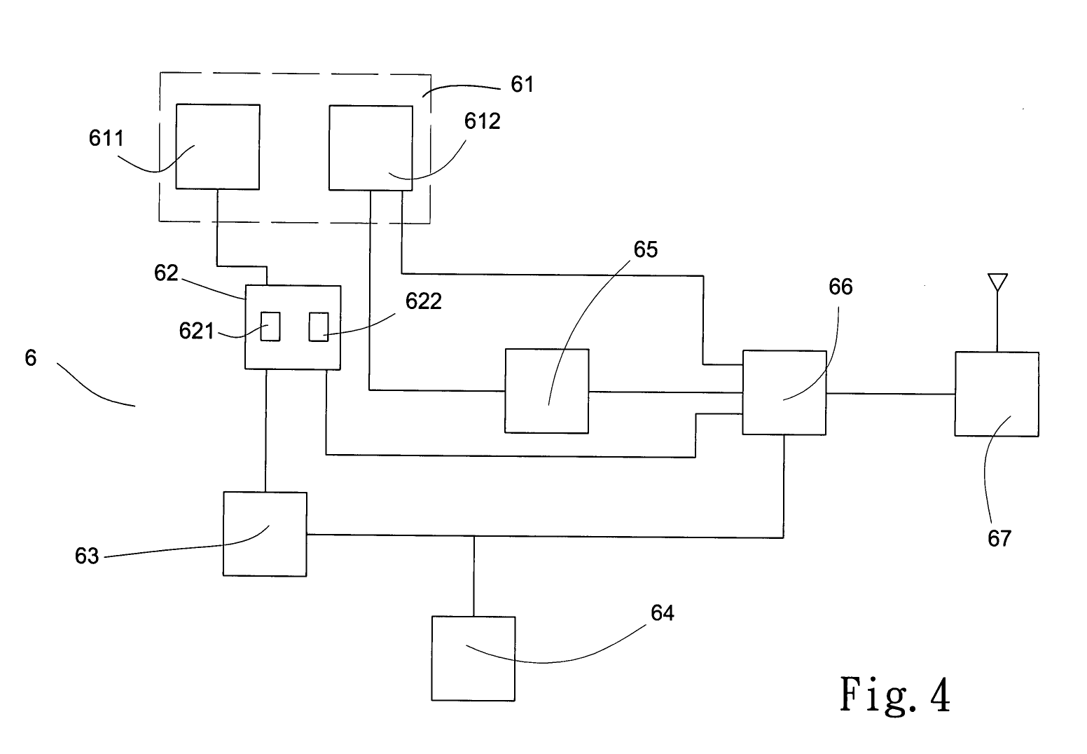

Referring to FIG. 3, wherein the video control device 8 of the improved game device enabling three-dimensional movement of the present invention basically comprises a microprocessor 81, a video control unit 82, the video display unit 83, a memory 84, the data reader device 85, a wireless transceiver 86, a signal input terminal 87 and the electronic gyroscopes 88, in which the electronic gyroscopes 88 comprise a transmitter unit 881, a receiver unit 882 and a switching unit 883. The switching unit 883 assumes a state that normally activates the receiver unit 882. Referring to FIG. 2 in conjunction with FIG. 4, after receiving a signal from the remote control signal transmitter 6, then the receiver unit 882 directly instructs the video control unit 82 to enable the video display unit 83 to display the video signals being input into the signal input terminal 87, accordingly providing functionality of a general television set with the signal input terminal 87 serving as an antenna device or wired signal transmission source terminal.

Whereas, if the wireless transceiver 86 receives wireless signals from the remote control signal transmitter 6, then the microprocessor 81 is notified to activate the switching units 883 of the electronic gyroscopes 88 to close operation of the receiver unit 882 and cause the transmitter unit 881 to transmit infrared rays to enable the remote control signal transmitter 6 to implement analysis of infrared rays received for game operation enabling three-dimensional movement. The electronic gyroscopes 88 are disposed at least two different positions (as depicted in FIG. 2), thereby enabling the remote control signal transmitter 6 to receive a transmitting source located at different positions and implement calculation of three dimensional distance and angle data.

Function of the switching unit 883 is to ensure that the video control device 8 is only implementing one operating mode at one time, that is, either operating as a television set or operating as a game machine, thereby providing the present invention with a safety function which prevents an adverse effect from occurring due to an operator mistakenly pressing the television set switch while playing a game.

The data reader device 85 refers to a device able to read a CD-ROM disk or a memory card such as a CF card (Compact Flash card), SD card (Secure Digital card), SDHC card (Secure Digital High Capacity card), MMC card (Multi Media card), MSPro card (Memory Stick Pro card), MINI SD card (Mini Secure Digital card), USB (Universal Serial Bus) mobile disk, and the like, thereby facilitating input of the accessed game programs into the memory 84 for immediate capture by the microprocessor 81 to provide the video control unit 82 with a basis for output to the video display unit 83.

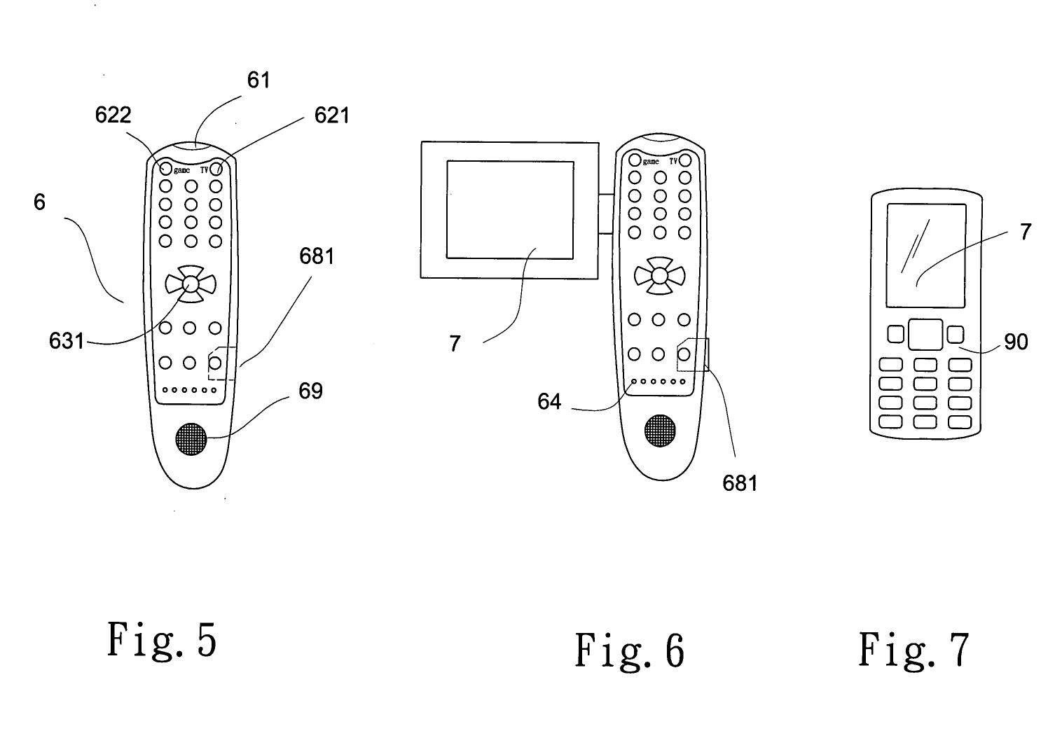

Referring to FIG. 4 and FIG. 5, which show a structural block diagram and an external view respectively of an embodiment of the remote control signal transmitter 6 of the improved game device enabling three-dimensional movement of the present invention, wherein the remote control signal transmitter 6 basically comprises an optical sensor 61, a switch 62, a key set 63, an LED (light-emitting diode) set 64, a calculating machine 65, a microprocessor 66 and a wireless transmitter unit 67. The optical sensor 61 comprises an infrared transmitter unit 611 and a receiver unit 612, and operation of the optical sensor 61 is subject to the control of the switch 62. The switch 62 has two control keys, one of which is a game key 622, and the other is a television key 621. Referring to FIGS. 4 and 5 in conjunction with FIG. 2, when the television key 621 is pressed down, then the infrared transmitter unit 611 of the optical sensor 61 remotely controls the video control device 8 and activates the video display unit 83 to enable the viewing of television programs; moreover, the key set 63 can be used for the operation of display unit signal controls, including selecting television channels, controlling sound volume, brightness, and so on, accordingly providing similar functionality to that of a general television remote control. Furthermore, the LED set 64 indicates the operating mode the user is using by an LED display, for example, if the user is playing a game, then the LED set 64 enables variable LED displays, thereby increasing entertainment effectiveness.

If the game key 622 is pressed down, then the infrared receiver unit 612 is simultaneously activated via the microprocessor 66, and the wireless transmitter unit 67 transmits a signal to the video control device 8, at which time, the user is able to select game rules, type, and so on, according to the functions of the predetermined key set 63, and after making selections, a start key 631 (see the embodiment depicted in FIG. 5) is pressed. Referring again to FIG. 2 and FIG. 3, when the wireless transceiver 86 receives the signal, then the transmitter units 881 of the electronic gyroscopes 88 are activated to transmit infrared rays, at which time three-dimensional movement to control game content is enabled, and the calculating machine 65 uses infrared rays received by the receiver unit 612 from each of the different positioned transmitter units 881 of the electronic gyroscopes 88 of the video control device 8 to calculate and analyze the near and far distances traveled through by the remote control signal transmitter 6, whereupon the microprocessor 66 is notified of the comparative data, which is then transmitted to the wireless transceiver unit 86 of the video control device 8 using the wireless transmitter 67. After mathematical operation by the microprocessor 81, the video control unit 82 is instructed to display position and movement of the main character in the game corresponding to the operator on the video display unit 83; accordingly, repeating such operations enables achieving the objective of three-dimensional game play.

Apart from use for three-dimensional games, the remote control signal transmitter 6 and the video control device 8 can also be designed for two-dimensional games.

Devices, including a card reader having a game interface (not shown in the drawings), a speaker 69 and the memory 84 can be located in the remote control signal transmitter 6, as well as having an internal display unit interface installed thereto, and by merely using an additional screen 7 device and inserting the game machine 681, then the remote control signal transmitter 6 can be used as a game machine (as depicted in FIG. 6), at which time, the calculating machine 65 calculates each key control data function of the game, and the microprocessor 81 integrates game data from the calculating machine 65 with data stored in memory. In actuality, functionality of the microprocessor 81 can be merged with that of the calculating machine 65.

Functionality of the aforementioned remote control signal transmitter 6 (with reference to FIG. 2) can be applied in a household television remote control, a cellular phone 90 (as depicted in FIG. 7) or a PDA (Personal Digital Assistant), as well as a wireless intercom. Accordingly, the video control device 8 used is not limited to a device having television functionality, but can also be designed for application in a overhead projector, a portable computer or any other electronic product able to control video pictures. In addition, a USB (Universal Serial Bus) slot can be located on the remote control signal transmitter 6 to enable external connection with electronic equipment, thereby enabling game information to be read into the remote control signal transmitter 6.

Effectiveness achieved by the improved game device enabling three-dimensional movement of the present invention is evident from the following:

1. Structure is light, portable and simple, and eliminates the need for additional devices required by the Wii game machine of the prior art, such as a main machine, connecting lines, and so on.

2. The video control device 8 used is not restricted to a television set (which Wii is), but is a design that has widespread application in video devices able to control video pictures, including overhead projectors, and the like.

3. Can be designed for use in a household television remote control, cellular phone, PDA, and related products without affecting original functional use thereof.

4. Applicable for use in portable computers, thereby enabling game playing anytime, anywhere.

5. Because the present invention is designed for use in existing products, apart from increasing additional game functionality, moreover, cost is low.

In conclusion, the improved game device enabling three-dimensional movement of the present invention is undoubtedly provided with improved inventiveness and advancement, convenience and practicability. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A game device enabling three-dimensional movement, comprising a wireless sensor game system structured from a main game machine, a remote control signal transmitter and a video display unit, wherein:
the main game machine comprises a microprocessor, a memory and a wireless transceiver, the main game machine is thin and small in size, and is directly inserted into an Input/Output interface slot of the display unit, thereby reducing wiring procedure and saving space;
the remote control signal transmitter is a short distance wireless transmitter, having functionality to transmit game control signals or display unit signal controls for changing channels on the display unit, adjusting sound volume, brightness, and the like;
the video display unit.

2. The game device enabling three-dimensional movement according to claim 1, wherein the main game machine uses an interface, such as USB (Universal Serial Bus), SD (Secure Digital), MSPro (Memory Stick Pro), CF (Compact Flash), to directly connect with the video display unit.

3. The game device enabling three-dimensional movement according to claim 1, wherein the game device and the remote control signal transmitter is a 2D or 3D game system.

4. The game device enabling three-dimensional movement according to claim 1, wherein the remote control signal transmitter is an externally connected small video display unit and the main game machine, and is an independent game machine device.

5. The game device enabling three-dimensional movement according to claim 1, wherein the remote control signal transmitter is additionally configured with wireless communication functionality, and is a wireless communication device, such as a portable mobile phone, a PDA (Personal Digital Assistant), and the like.
